(19) United States
(12) Patent Application Publication
(10) Pub. No.: US 2025/0236349 A1
(43) Pub. Date: Jul. 24, 2025

(54) LINKED DRIVE TRACK AND RELATED COMPONENTS AND METHODS

(71) Applicant: Splash Pool & Spa, Inc., Ningbo (CN)

(72) Inventors: Huaiping Wang, Ningbo City (CN); Paul Lambourn, Johannesburg (ZA); Michael Richard Tregoning, Edenvale (ZA)

(73) Assignee: Splash Pool & Spa, Inc., Ningbo (CN)

(21) Appl. No.: 18/418,973

(22) Filed: Jan. 22, 2024

(51) Int. Cl. B62D 55/21; B62D 55/125; B62D 55/26; B62D 55/32

(52) U.S. Cl. CPC B62D 55/21; B62D 55/125; B62D 55/26; B62D 55/32

(57) ABSTRACT

A drive track comprises a plurality of traction links connecting in an endless chain by a plurality of connecting links. Each traction link includes a traction pad having a traction face and a connection face, first and second connection passages being defined in the connection face. Each adjacent pair of the traction links is connected by an opposed pair of the connecting links. Each connecting link includes a connecting arm extending between first and second arm ends, first and second connecting posts extend inwardly from the first and second arm ends. Distal ends of the first and second connecting posts of each opposed pair of the connecting links interlock, respectively, within the adjacent first and second connection passages of each of the adjacent pairs of the traction links.

### FIELD OF THE INVENTION

The present invention relates to drive tracks for vehicles, and more particularly, to plastic, linked drive tracks for small vehicles.

### BACKGROUND OF THE INVENTION

It is well known to equip various utility vehicles with drive tracks. While tanks are perhaps the most famous example, such tracks are commonly used on many construction vehicles, some recreation vehicles (like snowmobiles) and even on much smaller vehicles (like toys and automatic swimming pool cleaners). While larger vehicles like tanks and large construction equipment typically employ tracks formed of a plurality of interconnected links, smaller equipment will frequently use a continuous track formed of rubber or other elastomeric materials. Such continuous tracks are typically lighter than a linked track and cost less initially. In linked tracks, on the other hand, it is possible to replace only the damaged or worn links. However, when damage or wear exceeds an acceptable limit in continuous tracks, the entire track must be replaced, resulting in potentially higher lifetime costs.

### SUMMARY OF THE INVENTION

In view of the foregoing, it is an object of the present invention to provide a drive track formed of a plurality of links that is well suited to be formed of plastic or other polymeric materials, easily assembled and repaired, and sufficiently rugged for frequent use. According to an embodiment of the present invention, a drive track comprises a plurality of traction links connecting in an endless chain by a plurality of connecting links. Each traction link includes a traction pad having a traction face and a connection face, first and second connection passages being defined in the connection face. Each adjacent pair of the traction links is connected by an opposed pair of the connecting links. Each connecting link includes a connecting arm extending between first and second arm ends, first and second connecting posts extend inwardly from the first and second arm ends. Distal ends of the first and second connecting posts of each opposed pair of the connecting links interlock, respectively, within the adjacent first and second connection passages of each of the adjacent pairs of the traction links.

According to an aspect of the present invention, the traction pad of each of the traction links includes an elastomeric contact material on the traction face. A remainder the traction pad of each of the traction links and an entirety of the plurality of connecting links are formed of a rigid polymeric material.

According to another aspect of the present invention, the connection face of each of the plurality of traction links includes first and second ridges separated by a valley. The first and second connection passages are defined in the first and second ridges, and opposing side walls extend between outer ends of the first and second ridges, enclosing opposite ends of the valley.

According to a further aspect of the present invention, the drive track is engaged with at least one drive sprocket having a plurality of teeth. A first portion of the plurality of teeth are received in respective ones of the valleys of a portion of the plurality of traction links. A second portion of the plurality of teeth are received between the first and second ridges of the adjacent ones of the portion of the plurality of traction links.

According to an additional aspect of the present invention, each of the distal ends of the first and second connecting posts of the plurality of connecting links includes at least a first inwardly-extending toothed prong. Preferably, each of the distal ends of the first and second connecting posts of the plurality of connecting links further includes a second inwardly-extending toothed prong offset by 180 degrees from the first inwardly-extending toothed prong. Advantageously, each of the first and second second inwardly-extending toothed prongs occupies greater than a 90 degree segment of a respective one of the distal ends of the first and second connecting posts.

According to a method aspect, a method of making a drive track includes interlocking distal ends of first and second posts of a plurality of connecting links inside, respectively, first and second connection passages defined in adjacent pairs of traction links to form an endless chain.

These and other objects, aspects and advantages of the present invention will be better appreciated in view of the drawings and following detailed description of preferred embodiments.

### BRIEF DESCRIPTION OF THE DRAWINGS

FIG. 1 is a perspective view of a drive track including a plurality of traction links connected in an endless chain by a plurality of connecting links, according to an embodiment of the present invention;

FIG. 2 is perspective view of a representative adjacent pair of the traction links connected by a representative opposed pair of the connecting links of FIG. 1;

FIG. 3 is an exploded perspective view of the traction links and connecting links of FIG. 2;

FIG. 4 is a detail view of area 4-4 of FIG. 1; and

FIG. 5 is a front view of an inner face of a representative one of the connecting links of FIG. 1.

### DETAILED DESCRIPTION OF PREFERRED EMBODIMENTS

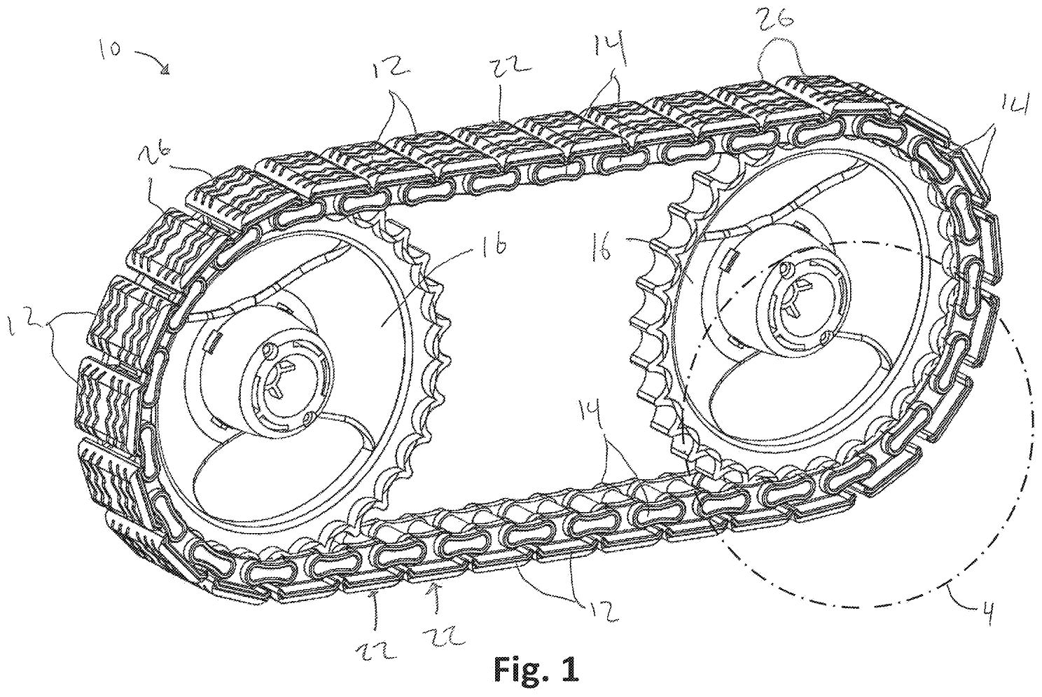

Referring to FIG. 1, according to an embodiment of the present invention, a drive track 10 includes a plurality of traction links 12 connected in an endless chain by a plurality of connecting links 14. Each pair of adjacent traction links 12 is connected by an opposed pair of connecting links 14, such that for an endless chain of any desired length, the track 10 will have twice any many connecting links 14 as traction links 12. By securing the drive track 10 around one or more drive sprockets 16, the drive track 10 can be driven to move an associated vehicle over an underlying surface.

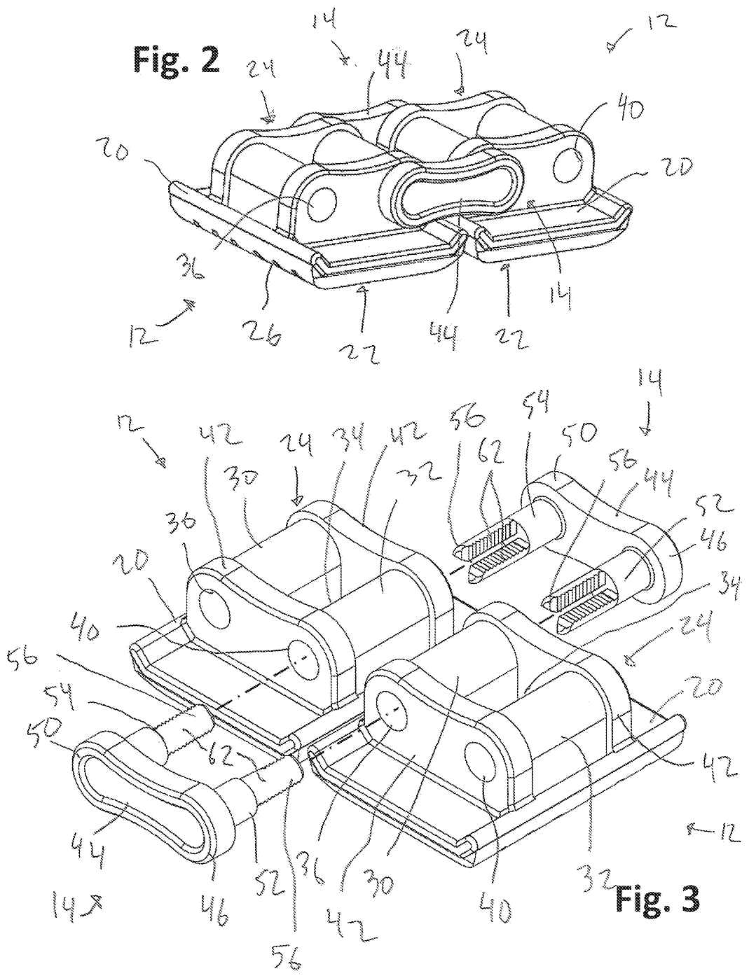

Referring also to FIGS. 2 and 3, each traction link includes a traction pad 20 having an outward-facing traction face 22 and inward-facing connection face 24. The traction face 22 of the traction pad 20 advantageously includes elastomeric contact material 26, with the remainder of the traction pad being formed of a rigid polymeric material. The elastomeric contact material 26 is preferably overmolded onto the remainder of the traction pad, although other methods of adhesion are possible within the scope of the present invention. A tread pattern can be formed in the elastomeric contact material 26.

The connection face 24 includes first and second ridges 30, 32 separated by a valley 34. First and second connection passages 36, 40 are defined in the first and second ridges 30, 32, respectively. Opposite ends of the valley 34 are enclosed by side walls 42, which extend between outer ends of the first and second ridges 30, 32

Each connecting link 14 includes a connecting arm 44 extending between first and second arm ends 46, 50. First and second connecting posts 52, 54, extend inwardly from the first and second arm ends 46, 50. Distal ends 56 of the posts 52, 54 of each opposed pair of connecting links 14 interlock, respectively, within the first and second connection passages 36, 40 of each adjacent pair of traction links 12. In other words, the first connecting posts 52 of each opposed pair of connecting links 14 interlock within the first connection passage 36 of one of the adjacent traction links 12 while the second connecting posts 54 of each opposed pair of connecting links 14 interlock within the second connection passage 40 of the other of the adjacent traction links 12. Each connecting link 14 is preferably formed in its entirety of a rigid polymeric material.

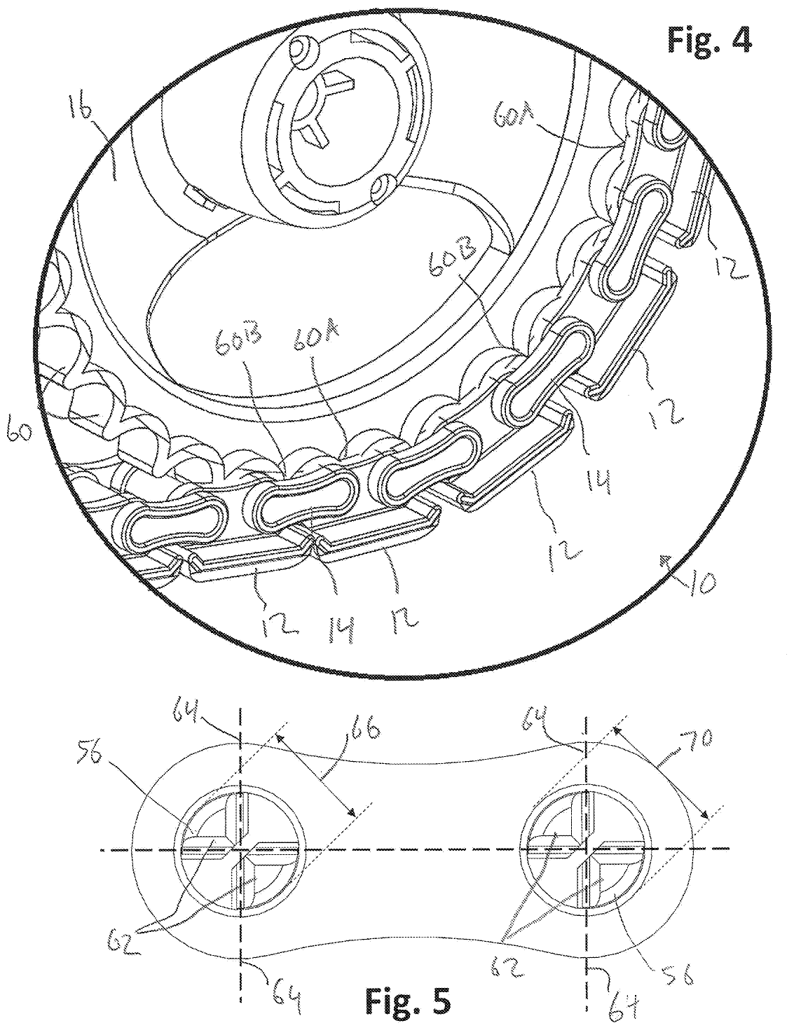

With the drive track 10 connected around the drive sprockets 16, the connecting links 14 and the connection faces 24 of the traction links 12 cooperate to keep teeth 60 of each drive sprocket 16 engaged with the traction links 12. Referring to FIG. 4. A first portion 60A of the teeth 60 are received in respective valleys 34 of a portion of the traction links 12 between the first and second ridges 30, 32 thereof. Lateral movement between the traction links 12 and the first portion 60A of the teeth 60 is restricted by the side walls 42.

A second portion 60B of the teeth 60 are between the first and second ridges of adjacent ones of the portion of the plurality of traction links 12. The lateral constraints imposed by the side walls 42 on the first portion 60A of the teeth 60 prevent lateral engagement of the second portion 60B of the teeth 60 with the opposed connecting links 14, which engagement would otherwise apply forces acting against the interlock therebetween.

Referring to FIGS. 3 and 5, the distal end 56 of each first and second connecting post 52, 54 of each of the connecting links 14 includes a pair of inwardly-extending toothed prongs 62. Preferably, the prongs 62 are offset from one another by 180 degrees and each occupies somewhat more than a 90 degree segment 64 of its distal end, ensuring firm engagement between opposed prongs 60 when pushed together within a first or second connection passage 36, 40.

Advantageously, an effective diameter 66 of each prong is slightly less than the outer diameter 70 of a proximal end 72 of each connecting post 52, 54 adjacent to the connecting arm 44. The outer diameter 70 of each proximal end 72 is more closely accommodated within its respective connection passage 36, 40 while the smaller diameter 66 allows for some outward flexure of the prongs 62 when interlocking.

To assemble a drive track, a sufficient number of traction links 12 is selected based on the desired length of the endless chain. Each adjacent pair of traction links 12 is connected by an opposed pair of connecting links 14 by interlocking first and second connecting posts 52, 54, respectively, within the adjacent first and second connection passages 36, 40 of each adjacent pair of traction links 12. The traction links 12 are arranged such that the traction faces 22 will all face outward when the endless chain is completed by connecting the first and last traction links 12 with a final opposed pair of connecting links 14.

When mounted around drive sprockets 16, a first portion 60A of the plurality of sprocket teeth 60 are received in the valleys 12 formed between the first and second connection passages 36, 40 of a portion of the plurality of traction links 12. A second portion 60B of the plurality of teeth are received between the first and second connecting passages 36, 40 of the adjacent ones of the portion of the plurality of traction links 12.

When any links 12, 14 become worn or damaged over time, such link(s) 12, 14 are simply removed by detaching the associated connecting links 14 and then inserting and reconnecting any new link(s). Accordingly, costs of the track 10 over the life time of an associated vehicle are reduced relative to a continuous elastomeric track. Additionally, the formation of most of the track 10 within rigid polymeric materials avoids or minimizes the stretch and attendant fit issues often associated with continuous elastomeric tracks over time.

The above-described embodiments are provided for illustrative purposes; the present invention is not necessarily limited thereto. Rather, those skilled in the art will appreciate that various modifications, as well as adaptations to particular circumstances, will fall within the scope of the invention herein shown and described and of the claims appended hereto.

What is claimed is:

1. A drive track comprising:
a plurality of traction links, each traction link including a traction pad having a traction face and a connection face, first and second connection passages being defined in the connection face;
a plurality of connecting links connecting the plurality of traction links in an endless chain, each adjacent pair of the traction links being connected by an opposed pair of the connecting links, each connecting link including a connecting arm extending between first and second arm ends, first and second connecting posts extending inwardly from the first and second arm ends, distal ends of the first and second connecting posts of each opposed pair of the connecting links interlocking, respectively, within the adjacent first and second connection passages of each of the adjacent pairs of the traction links.

2. The drive track of claim 1, wherein the traction pad of each of the traction links includes an elastomeric contact material on the traction face.

3. The drive track of claim 2, wherein a remainder the traction pad of each of the traction links is formed of a rigid polymeric material.

4. The drive track of claim 3, wherein an entirety of each of the plurality of connecting links is formed of a rigid polymeric material.

5. The drive track of claim 1, wherein the connection face of each of the plurality of traction links includes first and second ridges separated by a valley, the first and second connection passages being defined in the first and second ridges, opposing side walls extending between outer ends of the first and second ridges and enclosing opposite ends of the valley.

6. The drive track of claim 5, further comprising a drive sprocket having a plurality of teeth, a first portion of the plurality of teeth being received in respective ones of the valleys of a portion of the plurality of traction links and a second portion of the plurality of teeth being received between the first and second ridges of the adjacent ones of the portion of the plurality of traction links.

7. The drive track of claim 1, wherein each of the distal ends of the first and second connecting posts of the plurality of connecting links includes at least a first inwardly-extending toothed prong.

8. The drive track of claim 7, wherein each of the distal ends of the first and second connecting posts of the plurality of connecting links further includes a second inwardly-extending toothed prong offset by 180 degrees from the first inwardly-extending toothed prong.

9. The drive track of claim 8, wherein each of the first and second second inwardly-extending toothed prongs occupies more than a 90 degree segment of a respective one of the distal ends of the first and second connecting posts.

10. A method of making a drive track, the method comprising:
interlocking distal ends of first and second connecting posts of a plurality of connecting links inside, respectively, first and second connection passages defined in adjacent pairs of traction links to form an endless chain.

11. The method of claim 10, wherein the adjacent pairs of traction links are connected by the plurality of connecting links such that an elastomeric material on a traction face of a traction pad of each of the traction links faces outwardly.

12. The method of claim 10, further comprising mounting the drive track on a plurality of teeth of at least one drive sprocket such that a first portion of the plurality of teeth are received in valleys formed between the first and second connection passages of a portion of the plurality of traction links and a second portion of the plurality of teeth are received between the first and second connecting passages of the adjacent ones of the portion of the plurality of traction links.

13. A traction link of a drive track, the traction link comprising:
a traction pad having a traction face and a connection face, the connection face including first and second ridges separated by a valley, first and second connection passages being defined, respectively, in the first and second ridges and the traction face includes an elastomeric contact material.

14. The traction link of claim 13, wherein a remainder of the traction pad is formed of a rigid polymeric material.

15. The traction link of claim 14, wherein the elastomeric contact material is overmolded onto the rigid polymeric material.

16. The traction link of claim 15, wherein a tread pattern is formed in the elastomeric contact material.

17. The traction link of claim 12, wherein the connection face includes opposing side walls extending between outer ends of the first and second ridges and enclosing opposite ends of the valley.

18. A connecting link of a drive track, the connecting link comprising:
a connecting arm extending between first and second arm ends; and
first and second connecting posts extending inwardly from the first and second arm ends, distal ends of the first and second connecting posts including at least a first inwardly-extending toothed prong.

19. The connecting link of claim 18, wherein each of the distal ends further includes a second inwardly-extending toothed prong offset by 180 degrees from the first inwardly-extending toothed prong.

20. The connecting link of claim 19, wherein each of the first and second second inwardly-extending toothed prongs occupies more than a 90 degree segment of a respective one of the distal ends of the first and second connecting posts.

21. The connecting link of claim 20, wherein an entirety of each of the plurality of connecting links is formed of a rigid polymeric material.
